(19) United States
(12) Patent Application Publication
(10) Pub. No.: US 2007/0223796 A1
(43) Pub. Date: Sep. 27, 2007

(54) METHOD AND SYSTEM FOR AUTOMATIC EVALUATION OF AN IMAGE DATA SET OF A SUBJECT

(76) Inventor: Jens Guehring, Monmouth Junction, NJ (US)

Correspondence Address: SCHIFF HARDIN, LLP;PATENT DEPARTMENT, 6600 SEARS TOWER, CHICAGO, IL, 60606-6473, US

(21) Appl. No.: 11/688,986

(22) Filed: Mar. 21, 2007

(30) Foreign Application Priority Data
Mar. 21, 2006 (DE) 10 2006 012 943.1

(51) Int. Cl. G06K 9/00; G06K 9/46

(52) U.S. Cl. 382/128; 382/195

(57) ABSTRACT

In a method and system for automated evaluation of an image data set of a subject, first features are extracted from the image data set that are associated with the subject. An interdependency between the image data set of the subject and a reference system that corresponds to the image data set is determined, by the extracted first features being set in relation to corresponding second features in the reference system. Method steps relating to image evaluation that are predefined at the reference system, are adapted to the image data set using the determined interdependency. The image data set by executing the adapted method steps on the image data set. The evaluated image data set is stored in a storage medium and/or the evaluated image data set is visually presented.

### BACKGROUND OF THE INVENTION

1. Field of the Invention

The present invention concerns a method for automatic evaluation of an image data set of a subject, in particular of image data sets acquired with a medical imaging modality in digitized form.

2. Description of the Prior Art

In medical imaging there are various methods with which an image of a human body part can be acquired in a digitized manner. Particularly when the body part image data are stored in a 3D volume data set, a number of data sets result that usually represent slice images.

The multiple slice images conventionally have been assessed by a radiologist who establishes, by visual via inspection, whether pathological findings exist in the slice images. Since findings can be easily overlooked (due to the number of slice images), and so methods have been developed that identify suspicious points so that the attention of the radiologist is directed to these points.

Acquired images are also often first converted or edited by an algorithm into a form presentable to the radiologist. For example, ADC (Apparent Diffusion Coefficient”) maps that are important for stroke diagnosis are created in a method that evaluates the acquired, diffusion-weighted magnetic resonance tomography (MRT) images.

When the method and the geometry of the body part to be imaged are not too complex, the method can be designed to ruin automatically. For the most part however, the geometry of the body part is so variable and complex that automation of the method is problematic. Often individual method steps must be adapted to the specific inter-individual characteristics. This normally occurs through a semi-automatic design of the method wherein the method steps proceed automatically until a manual intervention is necessary.

Due to the interaction, a user is often occupied for a fairly long time with the implementation of the method, which leads to increased personnel costs in the implementation of the method. Furthermore, the result of the method is dependent on the type and manner of the interaction, which can vary dependent on the user. The desired constancy of the quality in the method result thus is not always present.

### SUMMARY OF THE INVENTION

An object of the present invention is to provide an image evaluation a method in which an automatic implementation can be executed for an image stored in an image data set. Furthermore, an object of the invention is to provide a medical imaging system with which an image can be automatically evaluated.

In accordance with the invention a method for automated evaluation of an image data set of a subject includes extraction of first features from the image data set that are associated with the subject, determination of an interdependency or correlation or interrelation between the image data set of the subject and a reference system that corresponds to the image data set, by the extracted first features being set in relation to corresponding second features in the reference system, adaptation of method steps for image evaluation, that are predefined at the reference systems to the image data set using the determined interdependency, evaluation of the image data set by executing the adapted method steps on the image data set, and storage of the evaluated image data set in a storage medium and/or visual presentation of the evaluated image data set

The reference system is thereby adapted to the subject stored in the image data set. Since the reference system can be a generalized (and thereby also idealized) form of the stored subject, method steps can be predefined particularly precisely, robustly and simply at the reference system. These method steps are then transferred to the image data set according to the determined interdependency. The method steps are thus adapted to the individual particulars of the image data set and of the subject stored therein.

The interdependency is determined by setting features of the subject and corresponding features of the reference system in relation to one another. Which features these are specifically depends on the subject to be imaged, the reference system and the type of the imaging. The features are typically prominent features that can be particularly easily located in the image data set or in the reference system and extracted therefrom. The features between various objects of the same type should not exhibit excessively large differences. When the features satisfy these conditions, the algorithms that are used for location and extraction of the features can be fashioned relatively simply.

The features that originate from the reference system are typically not newly extracted upon each implementation of the inventive method. For example, it can be sufficient to identify the prominent features in the reference system once and to locate the corresponding features in the image data set upon implementation of the method.

Using the inventive method it is now possible to apply the method steps that have been precisely defined once at the reference system to the evaluation of various image data sets, without a user having to adapt the individual method steps to the individual details of the subject.

The subject to be imaged is preferably a human or animal body or a portion thereof. In medical imaging, given the same medical questions the evaluation of the image data sets often ensues by the implementation of the same method steps. Nevertheless, due to individual characteristics it is often only possible with difficulty to automate the method steps. Such automation is now enabled by the inventive method that, in an embodiment, is applied to medical image data sets.

In one embodiment the reference system is a coordinate system with anatomical features of the subject to be imaged. Such a coordinate system is used, for example, in a Talairach system that describes the human brain. In addition to a coordinate system, in the Talairach system a number of planes are described that can also be located relatively simply in an image of the brain. This enables an image of a real brain and the standard brain described in the Talairach system to be set relative to one another in a relatively simple manner.

In another embodiment the reference system is an atlas of the body part to be imaged. Such an atlas can be generated, for example, from the imaging of one or more healthy control persons as is described in US 2003/0139659 A1.

In a further embodiment the reference system is established through an example measurement that, for example, can be effected once on a control person. The control person exhibits no anatomical peculiarities. Such a reference system can be obtained with particularly low effort.

The interdependency that is determined between the reference system and the image data set is preferably described by an affine, rigid or non-linear transformation. The type of transformation that is selected is adapted to the medical question and the organ system to be imaged, and represents a compromise between precision of the relation and calculation time for determination of the relation.

The aforementioned interdependency is preferably determined by a comparison of characteristic anatomical landmarks in the image data set and in the reference system. Such anatomical landmarks typically represent prominent characteristics in the image that therefore can be located easily. The transformations and interdependencies between the image data set and the reference system can be derived simply by a comparison of anatomical landmarks, in particular their size and spatial position.

In another preferred embodiment the interdependency is determined by a comparison of intensity distributions in the image data set and in the reference system. This has the advantage that no special landmarks must be determined or set in the image data set and in the reference system. A transformation is then considered as matching when specific regions in the transformed image and in the reference system vary to only slighter degrees with regard to their intensity values after the transformation. Should the image data set and the reference system additionally exhibit different contrasts (for example since the image data set and the reference system were acquired with different MRT sequences) the transformation is expanded such that these contrast differences are also taken into account.

In another embodiment the predefined method steps are defined in the form of script-like instructions. In another embodiment the method steps predefined at the reference system are defined by interactive implementation by a user at the reference system and this implementation is recorded. In both of these ways it is possible for a user to determine method steps as he or she would prefer them in the evaluation of the image. These two embodiments can be combined with one another so that a user can predefine the method steps at a reference system by the user executing them. A fine tuning thus can be implemented, for example via subsequent correction of the parameters in script-like code.

The predefined method steps can be determined from a pool of various predefined method steps dependent on a medical question. In this manner a user can start the method (for example by input of the symptoms, for example hemiparesis of the left side) and the method automatically then establishes steps matching the symptoms (in this case the location of hemorrhage and/or diffusion disruptions in the right motor cortex).

The method can be designed to allow a user to modify the individual predefined method steps via input of parameters. This is not necessary since the method is designed for an automatic execution, but gives the method additional flexibility.

The image data set is advantageously a 3D volume data set since it is particularly a data set of this type that requires a relatively complex evaluation. In various embodiments of the invention the 3D volume data set is generated by a computed tomography apparatus and/or by a magnetic resonance tomography apparatus.

The inventive medical imaging system has a computer that is programmed or built for implementation of the method described above.

### DESCRIPTION OF THE DRAWINGS

FIG. 1 illustrates a reference model of an organ to be examined with schematically shown method steps of the invention that are implemented for evaluation of the organ.

FIG. 2 illustrates an acquired 3D volume data set in which the image of an organ is stored, to which image the reference model corresponds.

FIG. 3 illustrates corresponding features between the reference model and the image of the organ, from which a transformation is determined that sets the reference model in relation to the image of the organ, and vice versa.

FIG. 4 illustrates the adaptation of the method steps to the image of the organ stored in the 3D volume data set using the determined transformation in accordance with the invention.

FIG. 5 is an overview flowchart of the inventive method.

### DESCRIPTION OF THE PREFERRED EMBODIMENTS

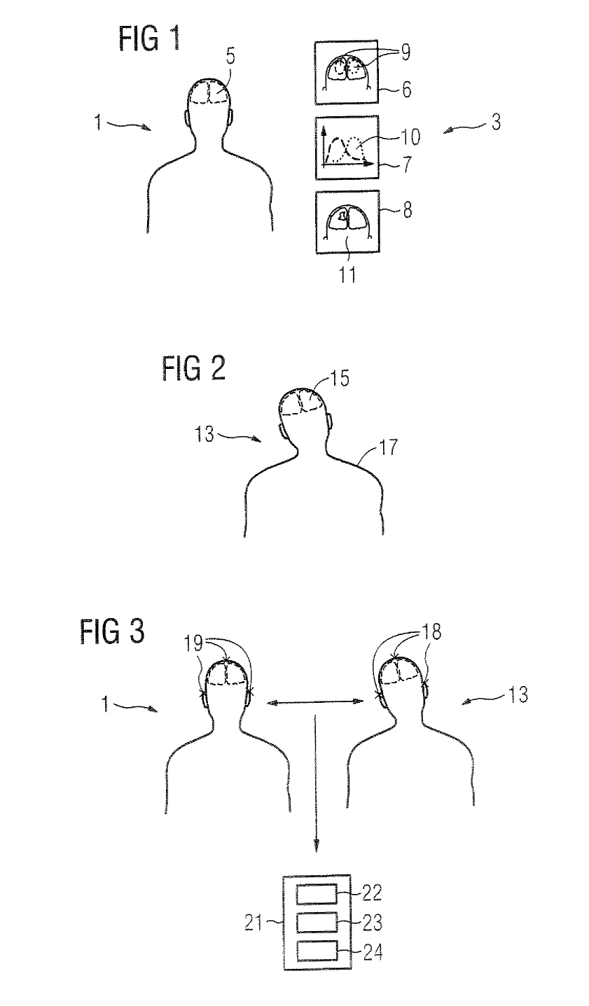

FIG. 1 and FIG. 2 respectively show a reference model 1 that reflects the image 13 of an organ to be examined in generalized form, and an image 13 of the organ to be examined with its individual characteristics.

The reference model 1 of an organ to be examined is schematically shown in FIG. 1. Method steps 3 that are implemented for evaluation of an image corresponding to the reference model 1 can be defined particularly precisely and robustly at such a reference model 1 that is free of individual peculiarities.

For explanatory purposes, the reference model 1 of a brain 5 at which three method steps 6, 7, 8 are defined for evaluation is shown only in an exemplary manner. More complex methods for evaluation are typically used; the basic principle of the invention, however, can be adequately explained using three comparably simple method steps 6, 7, 8.

In a first method step 6 specific regions that are focused upon with regard to the medical question are localized. Such regions are typically designated as ROIs 9 (“regions of interest”). In a second method step 7 these ROIs are evaluated with regard to specific features, for example their intensity value distribution 10. In a third method step 8 these results 11 obtained in the evaluation are in turn charted in the reference model 11.

Relative to the generalized and idealized reference model 1 from FIG. 1, FIG. 2 shows the image 13 of a brain 15 of a patient 17 that is stored in a image data set. During the acquisition the patient 17 has adopted an individual position and his brain 15 shows individual characteristics.

It is precisely these individual differences in the image 13 of the organ have previously made it difficult to realize automatic evaluation methods, although often the same method workflows are implemented given the same medical question. Until now a user has utilized evaluation methods in a semi-automatic manner, meaning that, although he or she implements the steps, he or she monitors and adapts each step to the individual characteristics.

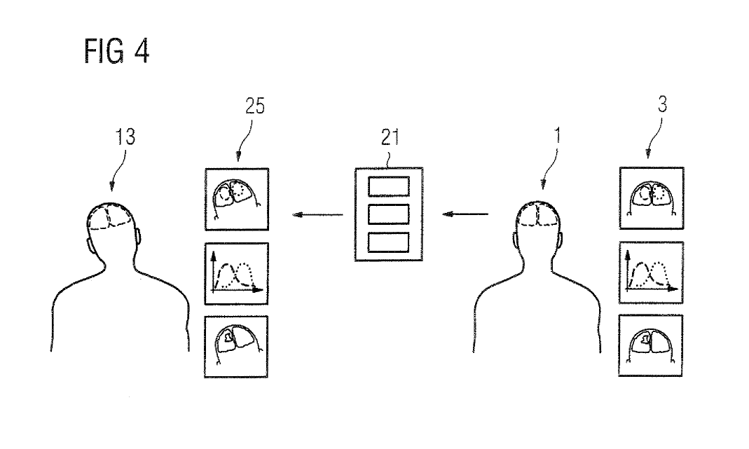

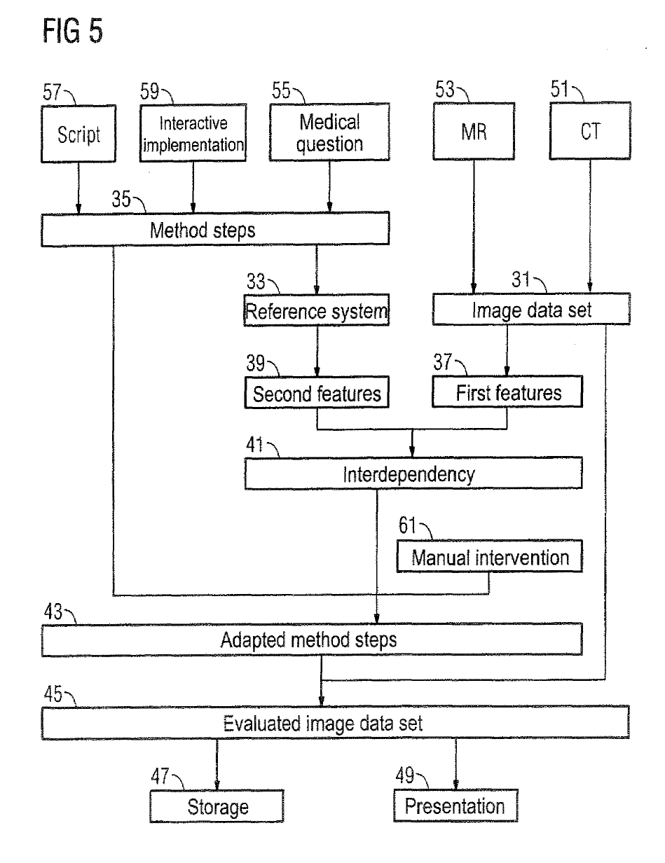

FIG. 3 and FIG. 4 show the basic features of the inventive method in which method steps 3 that are implemented at the reference model 1 are adapted to the image 13.

The reference model 1 is thereby adapted to the image 13 to be evaluated. When, for example, a T2-weighted MRT image of a brain should be evaluated, the reference model 1 at which the method steps are defined takes into account the characteristics that arise from the special T2-weighting of the brain.

The reference model 1 can be for example, an image-based atlas that was produced from images that originate from one or from a collective of control persons or also an exemplary measurement that was conducted on a control person.

Atlases can likewise be used that are based on an abstract specification of an organ system such as, for example, the Talairach system of the brain, which identifies specific regions of the brain that are of interest for medical questions using their position relative to prominent planes in the brain.

First characteristic features 18 are initially extracted from the image 13. As indicated in FIG. 3, such characteristic features 18 can be anatomical landmarks that are easy to locate and that have a localization that does not vary too significantly between individuals.

Second characteristic features 19 that correspond to the first features 18 are also extracted in an analogous manner from the reference model 1.

The first and the second features 18, 19 are now set in relation to one another. From this a transformation 21 is derived that describes the relation between the image 13 and the reference model 1 and with whose help the reference model 1 and the image 13 can be related to one another.

As schematically indicated, such a transformation 21 can be any of a number of different types of transformations.

For example, rigid transformations 22 describe a simple type of relation in which the reference model 1 and the image 13 are merely set in relation to one another via a rotation and/or a displacement. Affine transformations 23 furthermore take into account distortions and dilations. Going further, non-linear transformations 24 can more precisely detect differences between the reference model 1 and the image 13 in a spatially-dependent manner and significantly deform and distort the image 13 or, respectively, the reference model 1 differently in a spatially-dependent manner.

As just described, not only spatial transformations are suitable as the transformation 21; other types of transformations can also be applied. If, for example, the reference model 1 is adapted to a specific MRT acquisition sequence and the image 13 was acquired with an MRT acquisition sequence slightly deviating from said specific MRT acquisition sequence—when the reference model 1 and the image 3 thus differ in terms of their contrast—the transformation can also comprise an equalization of specific intensity values of specific regions so that reference model 1 and image 13 better coincide with one another and the different contrast is compensated.

The selected type of transformation 21 is thereby adapted to the medical question and the organ system to be imaged and represents a compromise between precision of the relation and calculation time for determination of the relation. For organ systems with a low inter-individual variability it can, for example, be sufficient to merely determine a rigid or affine transformation 22, 23 that sets the image 13 and the reference model 1 in relation to one another in a best possible manner. In the case of other organ systems (for example given extremities) that can be bent differently in an image, non-linear transformations 24 are necessary in order to set the image 13 and the reference model 1 in relation to one another. If anchorages of the organs (for example of the head or of an extremity) are used in turn in the acquisition, the image of the organ will exhibit a largely matching position so that only a simpler transformation is necessary in order to carry it over into a reference model.

The first and second features 18, 19 that are respectively extracted from the image 13 or from the reference model 1 and that form the basis for the transformation 21 to be determined thereby do not necessarily have to be anatomical landmarks as indicated in this exemplary embodiment. For example, intensity distributions in the 3D volume data set (for example the intensity distributions of the individual slice images) can also serve as features that are set in relation to intensity distributions in the reference body in order to determine therefrom the transformations 21 that best convert the image 13 and the reference model 1 into one another. Moment-based methods can likewise be used for specific images in order to determine a transformation 21 between reference model 1 and image 13. The latter cited methods use the intensity value distribution in the image in order to calculate corresponding abstracted quantities from this, similar to the calculation of diverse identifying values of a mass distribution such as a center of gravity or principle axes of inertia. Two varying images can thus be correlated in a simple manner in that the transformation from the abstracted values is calculated.

After the matching transformation 21 has been determined, the method steps 3 that have been defined at the reference model 1 are adapted to the image 13 with the aid of the determined transformation.

Method steps 3 that previously had to be executed in a semi-automatic manner (since the individual method steps were adapted to the individual characteristics) at the image 13 can be implemented in an automated manner in this way since the adaptation to the individual characteristics ensues with the aid of the transformation 21 determined beforehand. In the example shown, this transformation is primarily of importance for the adaptation of the first method step 6 (selection of specific ROIs 9) and of the third method step 3 (marking of the found differences in the image).

Using the method proposed here it is possible to automate a majority of examinations to be implemented, such that a user is shown specific found characteristics in the end result. The method is extended to its limits only when the image 13 and the reference model 1 deviate significantly from one another. This is not the case, however, in most routine examinations, such that the automatic adaptation and implementation of the method steps 3 represents a large gain for the user.

In addition to the location of specific ROIs, there is a series of further method steps that often required a manual adaptation in previously implemented methods. The determination of geometric parameters of imaged organs or pathological variations, the setting of a start point for a subsequent segmentation method in order to acquire the contours of an organ, the selection of specific slice positions in order to acquire defined images for a medical report and determination of start points or start regions given tractography of white brain matter are examples of steps in such a series.

FIG. 5 again schematically summarizes the significant features of the method and shows further features that are optional and give the method an additional flexibility and advantages.

The starting point of the method is an image data set 31 in which an image of a subject is stored. A reference system 33 that represents the object stored and shown in the image data set 31 in a generalized form stands in relation to the image data set 31. The method steps 35 that are implemented given the evaluation of the image data set 31 are defined at this reference system 33.

Respective corresponding first features 37 and second features 37 39 are extracted from the image data set 31 and from the reference system 33, the first and second features 37 and 39 being set in relation to one another in order to obtain the interdependency 41 between the image data set 31 and the reference system 33.

This interdependency 41 is used in order to obtain from the method steps 35 defined at the reference system 33 (which is defined at the reference system 33 [sic]) adapted method steps 43 that are adapted to the image stored in the image data set 31. The image data set 31 can be evaluated using the adapted method steps 43. The result of the evaluation, the evaluated image data set 45, can be stored in a storage medium 47 and/or be shown to a user in a representation 49.

The image data set 31 is advantageously acquired with a computed tomography apparatus 51 or an MRT apparatus 53, since it is particularly the images that are acquired with such methods that often require an intensive processing for evaluation. The method can also be applied, however, when the image data set 31 has been acquired in a different manner, for example by ultrasound or with conventional x-ray methods.

The method is advantageously implemented as a computer program in the computer of the apparatus with which the image data set 31 is also acquired.

The method steps 35 that are necessary for evaluation of the image data set 31 typically depend on the type of the data set and the medical question 55. They are preferably defined once by a user at the reference system 33 for a specific medical question 55 and a specific type of imaging. This can ensue, for example, by the user establishing the method steps 35 in abstract in a script-like code 57 to be executed. Another possibility is for the user to interactively implement the method steps 35 at the reference model in an exemplary manner, and this implementation 59 is recorded in order to repeat it later.

The evaluation then can be started by the user selecting the type of the image data set 31 and a specific medical question 55, whereupon the stored method steps 55 matching these, which method steps have been defined at the reference model 33, are drawn upon for the further method.

In an embodiment of the method the method can run wholly automatically when desired by the user, but the user can adapt specific method steps in a conventional manner in the context of a manual intervention 61 in order to thus compensate for a deviation between the reference system 33 and the image data set 31 that is overly large and thus is beyond the reasonable scope of being represented by the interdependency 41.

The applied method is not limited to medical imaging, but can also be applied for any imaging in which images of subjects to be evaluated are produced.

Although modifications and changes may be suggested by those skilled in the art, it is the intention of the inventor to embody within the patent warranted hereon all changes and modifications as reasonably and properly come within the scope of his contribution to the art.

I claim as my invention:

1. A method for automated evaluation of an image data set of a subject, comprising the steps of:
from an image data set of a subject, extracting first features associated with the subject;
automatically electronically determining an interdependency between said image data set of the subject and a reference system that corresponds to the image data set, by setting the extracted first features in relation to corresponding second features in the reference system;
automatically electronically adapting image evaluation steps, that are defined at the reference system, to said image data set using said interdependency;
automatically electronically evaluating said image data set by executing the adapted image evaluation steps on the image data set, to produce an evaluated image data set; and
performing at least one of storing said evaluated image data set in a storage medium and visually presenting said evaluated image data set.

2. A method as claimed in claim 1 comprising employing, as said image data set, an image data set representing a subject selected from the group consisting of a human subject, an animal subject, a human body part, and an animal body part.

3. A method as claimed in claim 2 comprising employing, as said reference system, a coordinate system comprising anatomical features of said subject,

4. A method as claimed in claim 2 wherein said subject is selected from the group consisting of an animal body part and a human body part, and comprising using, as said reference system, an atlas of said body part.

5. A method as claimed in claim 2 comprising generating said reference system by obtaining an image of an example subject, other than said subject.

6. A method as claimed in claim 2 comprising determining said interdependency by electronic comparison of characteristic anatomical landmarks in said image data set and in said reference system.

7. A method as claimed in claim 2 comprising determining said independency by automatically comparing intensity distributions in said image data set and in said reference system.

8. A method as claimed in claim 2 comprising establishing said defined image evaluation steps dependent on a medical question.

9. A method as claimed in claim 1 comprising mathematically defining said interdependency with a transformation selected from the group consisting of affine transformations, rigid transformations, and non-linear transformations.

10. A method as claimed in claim 1 comprising defining said image evaluation steps at said reference system as script-like instructions.

11. A method as claimed in claim 1 comprising defining said image evaluation steps at said reference system by manual interaction of a user with said reference system.

12. A method as claimed in claim 1 comprising modifying said image evaluation steps by manually entering parameters into said reference system.

13. A method as claimed in claim 1 comprising employing a 3D volume data set as said image data set.

14. A method as claimed in claim 13 comprising acquiring said 3D volume data set with an imaging modality selected from the group consisting of computed tomography apparatuses and magnetic resonance tomography apparatuses.

15. An image evaluation system for automated evaluation of an image data set of a subject, comprising:
a computer that, from an image data set of a subject, extracts first features associated with the subject, and automatically determines an interdependency between said image data set of the subject and a reference system that corresponds to the image data set, by setting the extracted first features in relation to corresponding second features in the reference system, and automatically adapts image evaluation steps, that are defined at the reference system, to said image data set using said interdependency, and automatically evaluates said image data set by executing the adapted image evaluation steps on the image data set, to produce an evaluated image data set;
a storage medium in communication with said computer in which said evaluated image data set are stored; and
a display in communication with said computer at which said evaluated image data set is visually presented as an image.

16. An image evaluation system as claimed in claim 15 wherein said computer employs, as said image data set, an image data set representing a subject selected from the group consisting of a human subject, an animal subject, a human body part, and an animal body part.

17. An image evaluation system as claimed in claim 16 wherein said computer employs, as said reference system, a coordinate system comprising anatomical features of said subject,

18. An image evaluation system as claimed in claim 16 wherein said subject is selected from the group consisting of an animal body part and a human body part, and wherein said computer uses, as said reference system, an atlas of said body part.

19. An image evaluation system as claimed in claim 16 comprising an imaging system that generates said reference system by obtaining an image of an example subject, other than said subject.

20. An image evaluation system as claimed in claim 16 wherein said computer determines said interdependency by electronic comparison of characteristic anatomical landmarks in said image data set and in said reference system.

21. An image evaluation system as claimed in claim 16 wherein said computer determines said independency by automatically comparing intensity distributions in said image data set and in said reference system.

22. An image evaluation system as claimed in claim 16 wherein said computer establishes said defined image evaluation steps dependent on a medical question.

23. An image evaluation system as claimed in claim 15 wherein said computer mathematically defines said interdependency with a transformation selected from the group consisting of affine transformations, rigid transformations, and non-linear transformations.

24. An image evaluation system as claimed in claim 15 comprising an input unit connected to said computer allowing said image evaluation steps to be defined at said reference system as script-like instructions.

25. An image evaluation system as claimed in claim 15 comprising an input unit connected to said computer allowing said image evaluation steps to be defined at said reference system by manual interaction of a user with said reference system.

26. An image evaluation system as claimed in claim 15 comprising an input unit connected to said computer allowing modification of said image evaluation steps by manually entering parameters into said reference system.

27. An image evaluation system as claimed in claim 15 wherein said computer employs a 3D volume data set as said image data set.

28. An image evaluation system as claimed in claim 27 comprising an imaging modality selected from the group consisting of computed tomography apparatuses and magnetic resonance tomography apparatuses that acquires said 3D volume data set.
